(19) United States
(12) Patent Application Publication
(10) Pub. No.: US 2026/0276191 A1
(43) Pub. Date: Sep. 17, 2026

(54) MULTILAYER ACOUSTIC ATTENUATOR AND LIGHT REFLECTOR

(71) Applicant: Focal Point, LLC, Chicago, IL (US)

(72) Inventors: Randal Abbott Zala, Chicago, IL (US); Daniel Matthew Kohnen, St Louis, MO (US); Justin Banker Peart, Clarendon Hills, IL (US); Bonnie Davis, Chicago, IL (US)

(21) Appl. No.: 19/078,948

(22) Filed: Mar. 13, 2025

(51) Int. Cl. F21V 33/00; B32B 1/00; B32B 3/26; B32B 7/02; B32B 37/14; B32B 38/00; F21S 8/04; G10K 11/168

(52) U.S. Cl. CPC F21V 33/0052; B32B 1/00; B32B 3/263; B32B 7/02; B32B 37/14; B32B 38/0012; F21S 8/04; G10K 11/168; B32B 2307/102; B32B 2307/416; B32B 2307/718; B32B 2307/7376; B32B 2457/00

(57) ABSTRACT

A light fixture according to one or more embodiments may include a substantially concave, multi-layer baffle and a luminaire. The baffle includes a first layer composed of a first material having a first weight, the first layer being configured to attenuate sound, and a second layer composed of a second material having a second weight, the second layer being configured to reflect light. The luminaire is positioned below the baffle and configured to emit light at least partially toward the second layer, which redirects the emitted light away from the baffle.

### BACKGROUND

Sound attenuation refers to the reduction of sound intensity or energy as it travels through a medium or interacts with a material. Certain materials have the ability to dampen sound and reduce echoes, making them ideal for use in acoustic applications. These materials, referred to herein as acoustic attenuators or baffles, work by absorbing a portion of a sound's energy and converting it into a different form of energy (e.g., heat), rather than reflecting it back into the environment.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

An example embodiment includes a light fixture including a substantially concave, multi-layer baffle and a luminaire positioned below the baffle and emitting light at least partially toward the baffle. The baffle includes a first layer of material configured to attenuate sound and a second layer of material configured to attenuate sound and/or reflect light (e.g., via a reflective surface or color). The light may emanate from a luminaire that is suspended from the baffle.

In some embodiments, the multi-layer baffle also includes a third layer, which may be positioned in between the first and second layers. In a three-layer configuration, the first (top) layer may comprise substantially 33% of the overall thickness of the baffle, the second (bottom) layer may comprise substantially 13% of the overall thickness of the baffle, and the third (middle) layer may comprise substantially 54% of the overall thickness of the baffle. Further, the top layer has a weight between 890 and 1420 gsm, the middle layer has a weight between 1000 and 2500 gsm, and the bottom layer has a weight between 400 and 600 gsm.

In some embodiments, the baffle may have a uniform or non-uniform thickness. If non-uniform, the thickness of the baffle may range from ~20 mm (e.g., at the center) to ~5 mm (e.g., at the edge). The baffle may have any geometric form, such as a rounded hexagonal form. The baffle may have any kind of curvature, such as a nonlinear curvature that is flatter at the center and that becomes more curved toward the edge.

Another example embodiment includes a method of manufacturing a light fixture. The method includes forming a multi-layer baffle with top, middle, and bottom layers, with each layer having a different material weight. The method also includes pressing the multi-layer baffle into a substantially concave shape with a non-uniform cross-section. The method further includes integrating a luminaire positioned below the multi-layer baffle to emit light at least partially toward the multi-layer baffle.

In some embodiments, the top layer may comprise approximately 33% of the overall thickness of the baffle, the middle layer(s) may comprise approximately 54% of the overall thickness of the baffle, and the bottom layer may comprise approximately 13% of the overall thickness of the baffle. The top layer has a weight between 890 and 1420 gsm, the middle layer has a weight between 1000 and 2500 gsm, and the bottom layer has a weight between 400 and 600 gsm.

In some embodiments, the baffle may have a uniform or non-uniform thickness. If non-uniform, the thickness of the baffle may range from ~20 mm (e.g., at the center) to ~5 mm (e.g., at the edge). The baffle may have any kind of curvature, such as a nonlinear curvature that is flatter at the center and becomes more curved toward the edge.

Another example embodiment includes an acoustic attenuator. The acoustic attenuator includes a substantially concave, multi-layer baffle having a non-uniform thickness. The baffle includes top, middle, and bottom layers, each layer having a different material weight. The bottom layer includes a bottom surface configured to reflect light away from the bottom surface and reflect/attenuate sound from below the bottom surface.

In some embodiments, the first (top) layer may comprise approximately 33% of the overall thickness of the baffle, the second (middle) layer(s) may comprise approximately 54% of the overall thickness of the baffle, and the third (bottom) layer may comprise approximately 13% of the overall thickness of the baffle.

In some embodiments, the acoustic attenuator may include a receptacle at the center of the acoustic attenuator for receiving a luminaire.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein, including in the various drawings and figures, are not to be interpreted as limiting, but merely as a representative basis for teaching one skilled in the art to variously employ one or more illustrative embodiments.

FIG. 1 is a top perspective view of an exemplary light fixture.

FIG. 2 is a bottom perspective view of the light fixture of FIG. 1.

FIG. 3 is a bottom view of the light fixture of FIG. 1.

FIG. 4 is an elevated side view of the light fixture of FIG. 1.

FIG. 5 is an exploded view of the light fixture of FIG. 1.

FIG. 6 is a top view of the baffle of the light fixture of FIG. 1.

FIG. 7 is an elevated side cross-sectional view of the baffle of the light fixture of FIG. 1 taken along line A-A of FIG. 6.

FIG. 8 is a flow diagram of a method of manufacturing the light fixture of FIG. 1.

### DETAILED DESCRIPTION

Reference will now be made in detail to various embodiments, examples of which are illustrated in the accompanying drawings. While this disclosure includes certain embodiments, it will be understood the disclosure is not intended to limit the claims to these embodiments. On the contrary, the disclosure is intended to cover alternatives, modifications, and equivalents, which may be included within the spirit and scope of the claims. Furthermore, in this detailed description, numerous specific details are set forth in order to provide a thorough understanding. However, one of ordinary skill in the art will appreciate that the subject matter of the present disclosure may be practiced without these specific details. In other instances, well known methods, procedures, and components have not been described in detail as not to unnecessarily obscure aspects of the present disclosure.

An acoustic attenuator and a baffle are both devices used to control sound. An acoustic attenuator is a device designed to reduce the intensity of sound waves by absorbing and/or dissipating their energy. Attenuators typically use sound-absorbing materials, such as acoustic foams or fiberglass, to convert sound energy into another form of energy (e.g., heat), which is then dissipated. A goal of an attenuator includes reduction of the overall sound level or minimization of the transmission of sound from one area to another, inhibiting the reflection of the sound back into the medium or environment in which it has traveled. Attenuators can be used in a variety of applications, including soundproofing, noise reduction, and acoustic treatment.

A baffle is a device used to redirect and/or mitigate sound and/or light energy. Baffles are typically rigid or semi-rigid panels that are placed in the path of sound or light waves to alter their direction or prevent them from passing through. Baffles can be used to control the dispersion of sound and/or light.

Various embodiments of this disclosure include a device configured to be both an acoustic attenuator (e.g., for absorbing sound) and a baffle (e.g., for mitigating sound propagation and redirecting light). The device, referred to herein simply as a baffle, can be used independently. For example, the device may be hung on a wall for sound treatment of a room. The baffle may also or instead be used as part of a light fixture. For example, the baffle and a light source (referred to herein as a luminaire) may be combined to form a light fixture.

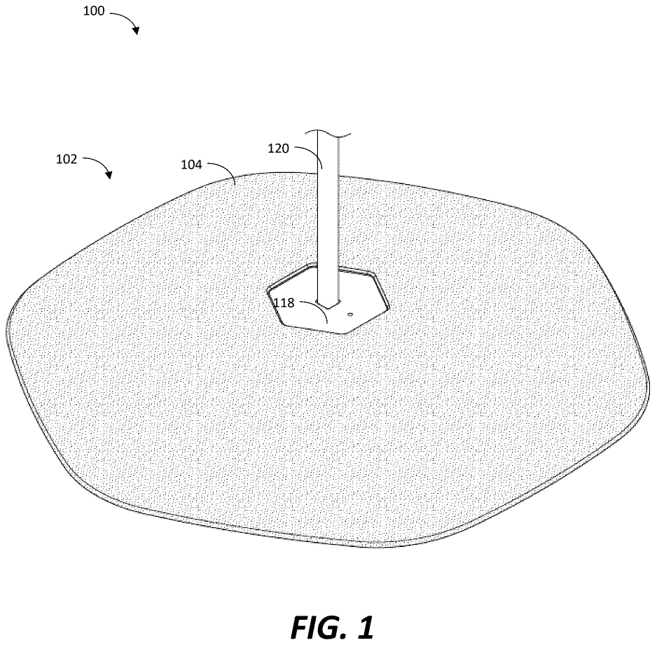

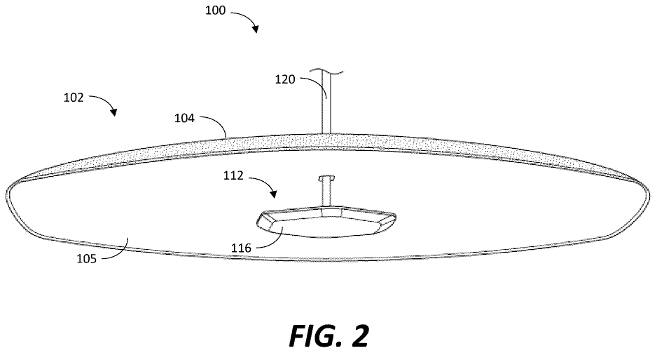

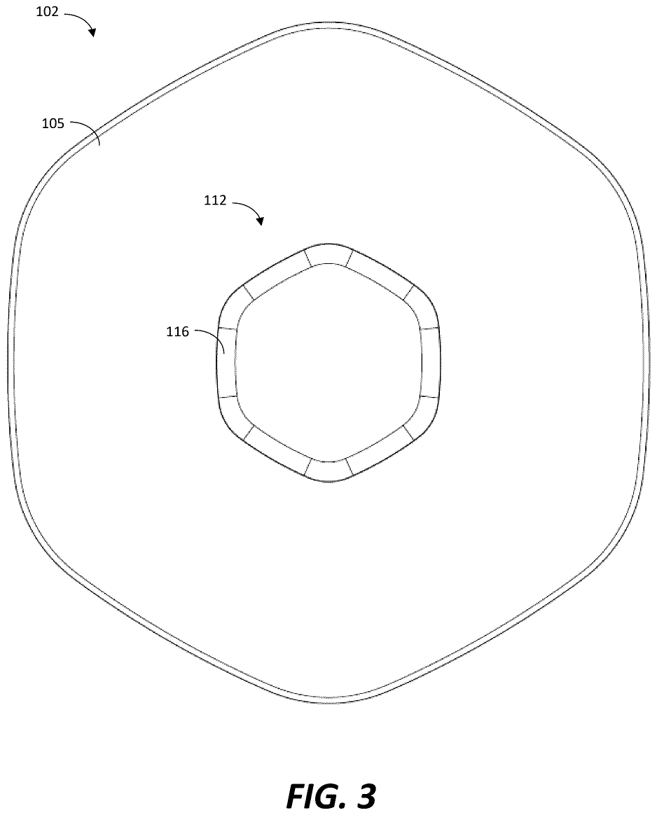

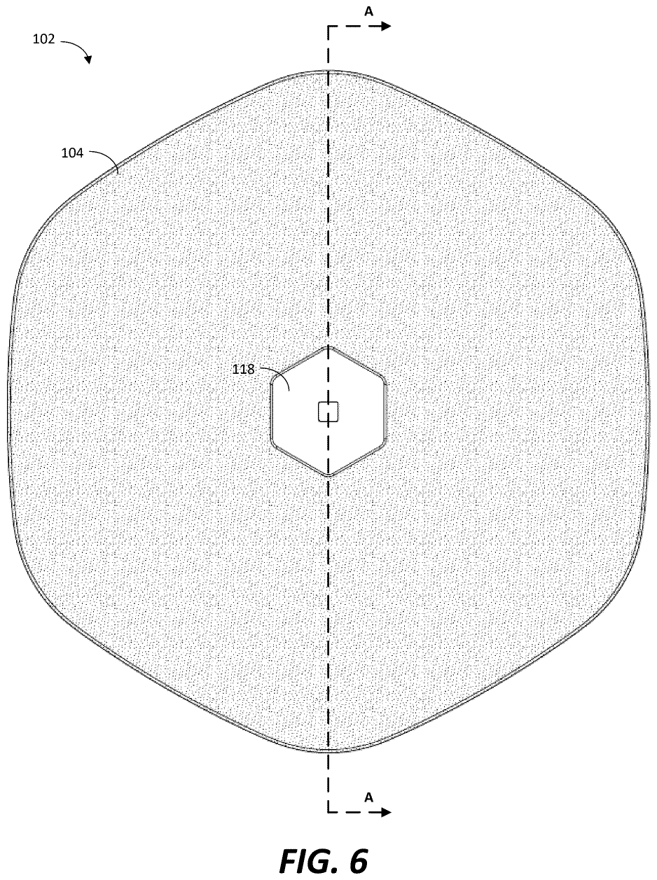

FIGS. 1-7 are various views of an example light fixture 100. The light fixture 100 comprises a luminaire 112 that serves as a light source and a baffle 102 that functions to influence both the lighting effect and acoustic properties of the surrounding environment. In one example, the light fixture 100 is configured as a pendant light, suspended from a ceiling, though other configurations, such as ceiling-mounted or wall-mounted variations, are also possible (with or without the luminaire 112). The baffle 102 may have a rounded hexagonal form measuring 27″ or 42″ in diameter, although other shapes and/or diameters are possible.

The luminaire 112 may be suspended from a surface (e.g., a ceiling) via a suspension mechanism 120, such as a cable, rod, cord, beam, tube, stem, and/or any other suitable item. The suspension mechanism 120 may be configured to facilitate the connection of the luminaire 112 to a power supply. For example, the suspension mechanism 120 may be a hollow conduit allowing wiring to pass through from the ceiling to the luminaire 112.

The baffle 102 may be connected to the luminaire 112 via an attachment mechanism 118. The attachment mechanism 118 may include a receptacle or aperture within the baffle 102 that allows the suspension mechanism 120 to pass through the baffle 102. The attachment mechanism 118 may also include receptacles for one or more fasteners for holding the baffle 102 in place on the suspension mechanism 120.

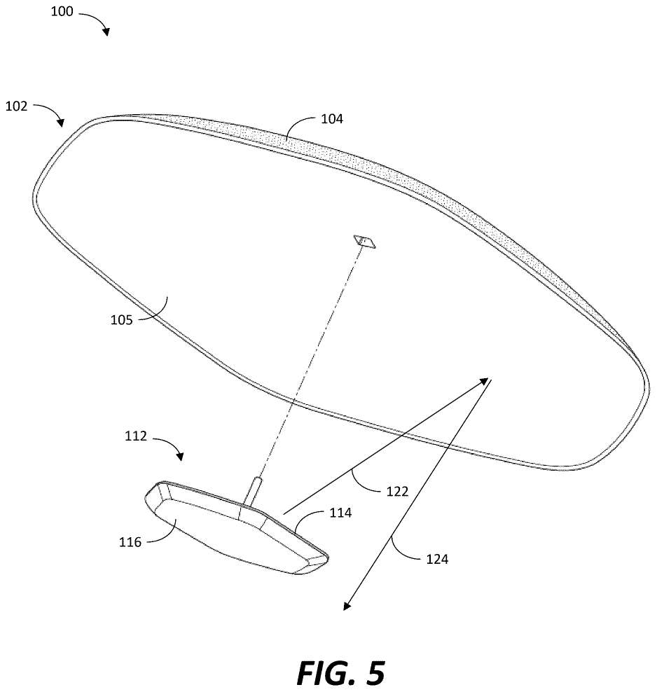

The baffle 102 may be positioned above the luminaire 112, which emits light upward (e.g., in a direction 122, as shown in FIG. 5) toward the bottom surface 105 of the baffle 102. The baffle 102, having a substantially concave or otherwise contoured form angled toward the luminaire 112, reflects the light back downward (e.g., in a direction 124, as shown in FIG. 5), producing a soft, ambient illumination that has the benefits of reducing glare and creating a more uniform light distribution. This indirect lighting effect is particularly advantageous in environments where a gentle, evenly dispersed light is preferred, such as offices, restaurants, or residential spaces. In some embodiments, the baffle 102 may have a substantially concave or otherwise contoured form angled away from the luminaire 112.

The baffle 102 may be designed to interact with the emitted light in various ways depending on the material properties and surface characteristics of the bottom surface 105. The bottom surface 105 of the baffle 102 may have a matte or textured finish to scatter light more effectively or a reflective coating to enhance luminous output. The bottom surface 105 of the baffle 102 may also have a lighter color to enhance luminous output. The top surface 104 of the baffle 102 may have the same or different material properties and/or surface characteristics tailored to the desired sound attenuation properties of the baffle 102.

The baffle 102 may also be designed to interact with sound by dampening and absorbing sound energy depending on the material properties and/or surface characteristics of the layers of the baffle 102. For example, a baffle 102 with three layers may include a hard top layer, a soft middle layer, and a firm bottom layer. The top layer may help decouple the baffle 102 from a wall, reducing the transmission of sound energy through the baffle 102 and into the wall, which can contribute to reverberation and sound reflections. The middle layer may make up approximately half of the thickness of the baffle 102 and is formed from one or more soft materials. The softness and thickness of the middle layer allow it to effectively dampen sound waves, particularly mid-to high-frequency sound waves (e.g., 100 Hz<f<8000 Hz). The bottom layer, which may be closest to the sound, helps provide a gradual transition from the air to the soft middle layer, allowing sound waves to enter the baffle 102 more effectively. The bottom layer may be effective at attenuating low-to mid-frequency sound waves (e.g., 50 Hz<f<500 Hz) by helping dissipate their energy as they enter the baffle 102. In this way, the baffle 102 improves acoustic performance within a space by mitigating excess noise and reverberation.

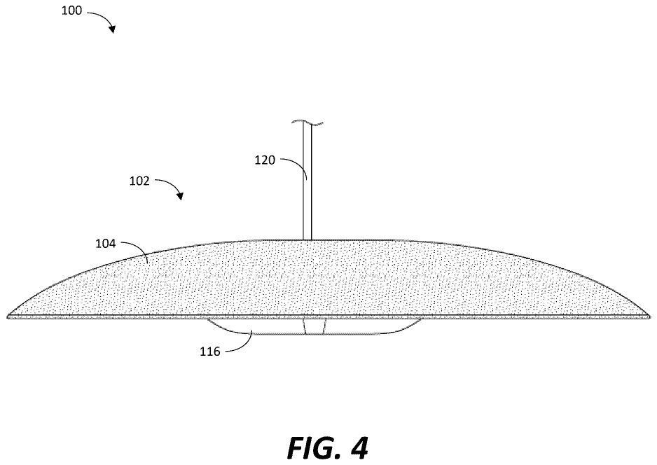

The baffle 102 may also be designed to interact with light and sound in various ways depending on its concavity. In some embodiments, the concavity is linear, following a consistent curve or angular slope across its span. In some embodiments, the concavity is nonlinear, where the central region of the baffle 102 remains relatively flatter, while the curvature increases progressively toward the edges, best seen in FIG. 4. This variation in curvature can further refine the distribution of reflected light, as well as influence the acoustic absorption characteristics by modifying the way sound waves interact with the surface of the baffle 102. Additional contouring possibilities include asymmetric curvatures, stepped or faceted concavities, distributed flat regions, or compound curves that incorporate multiple radiuses to achieve specific aesthetic and/or functional effects.

In some embodiments, the luminaire 112 may also or instead redirect (e.g., reflect) light downward, away from the baffle 102. For example, the luminaire 112 may be a light bulb that radiates light in all directions, and the light that radiates toward the baffle 102 may be reflected back downward.

While the light fixture 100 can function as a pendant light, alternative embodiments include configurations where the luminaire 112 is embedded within a ceiling structure, directing light outward toward an overhead baffle 102 affixed to the ceiling surface. In yet another example, the luminaire 112 could be integrated into a wall-mounted structure, where the baffle 102 acts both as a sound-absorbing wall panel and a reflective surface that redirects light into the room and away from the light fixture 100. The design allows for flexibility in lighting arrangements, making it adaptable to various architectural settings and lighting preferences.

By combining lighting and sound control into a single fixture, the light fixture 100 and the baffle 102 enhance both the visual and auditory experience, making it particularly suitable for environments where both lighting quality and noise reduction are important considerations.

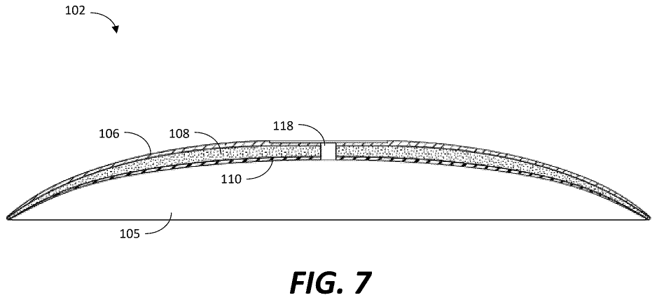

As shown in FIG. 7, the baffle 102 can include a plurality of layers of materials. The multi-layer construction of the baffle 102 can be configured to balance both sound absorption and light reflection. For example, the composition (e.g., material and/or weight) and thickness of each layer can be adjusted to fine-tune the behavior of the baffle 102 in different environments.

Some embodiments include a two-layer configuration in which the baffle 102 includes a top layer 106 and a bottom layer 110. The hard top layer 106 may provide structural integrity and impact the reflection and diffusion of sound waves, preventing excessive absorption while maintaining clarity in a space. The firm bottom layer 110 may play a dual role in both sound absorption and light redirection. Its material properties can be adjusted to balance these functions, providing effective acoustic dampening while optimizing the reflection and diffusion of light.

Some embodiments, e.g., as shown in FIG. 7, include a three-layer configuration in which a middle layer 108 is introduced between the top layer 106 and the bottom layer 110 to enhance the acoustic performance of the baffle 102. The middle layer 108 may serve as a transitional zone, dissipating sound energy more effectively, for example, by targeting mid-to-high frequency noise. By incorporating multiple layers where each layer has a separate material weight, the three-layer construction provides a more nuanced control over reverberation and sound absorption while still allowing the bottom layer 110 to function as a light-reflective surface.

The ratio between the layers of the baffle 102 can be adjusted to fine-tune acoustic and/or optical performance. In one example, the top layer 106 represents approximately 33% of the thickness of the baffle 102, the middle layer 108 represents approximately 54%, and the bottom layer 110 represents approximately 13%. This distribution allows for a progressive dissipation of sound energy while maintaining structural stability and effective light redirection. The top layer 106 may remain dominant in providing rigidity and sound diffusion, while the middle layer 108 maximizes absorption and the bottom layer 110 serves to both refine the final acoustic effect and enable proper light distribution.

In some embodiments, the thickness of the baffle 102 may be non-uniform. For example, the thickest part of the baffle 102 may reach 20 mm, while the thinnest areas may taper down to 5 mm, although other thicknesses (greater or less than 20 mm and greater or less than 5 mm) are possible. This variation in thickness may contribute to both the acoustic and optical characteristics of the light fixture 100. A thicker section may provide greater sound absorption and rigidity, whereas thinner sections allow for more flexibility in shaping the light reflection profile and achieving a refined diffusion effect. In some embodiments, the thickness of the baffle 102 may be uniform (e.g., 20 mm throughout).

The multi-layer baffle 102 may be constructed using polyethylene terephthalate (PET) materials with varying weights and various compositions of recycled and virgin materials. Each layer may be designed to balance structural integrity, acoustic absorption, and optical performance, tailoring functionality in both sound attenuation and light reflection.

The top layer 106 may be configured for strength and controlled rigidity. Accordingly, the top layer 106 may include a smooth, plastic-like texture, which may result in an effective sound diffusion surface while also providing durability and structural support for the baffle 102 and mounting components. The top layer 106 may have a Shore D hardness of 30-60. The top layer 106 may be constructed from plastic, polyester fiber, PET felt, compressed fiberglass panel, aluminum honeycomb panel, thermoplastic acoustic composite, bio-based acoustic panel (e.g., cork or hemp fiber), and/or any other suitable material. The weight of the top layer 106 may range from 890 to 1420 grams per square meter (gsm).

The middle layer 108, when present, may be an intermediary in the acoustic absorption process, dissipating energy that passes through the bottom layer 110 before it reaches the top layer 106. The middle layer 108 may improve overall attenuation without compromising the structure of the baffle 102. The middle layer 108 may have a Shore 00 hardness of 0-20. The middle layer 108 may be constructed from low-density PET fiber, open-cell foam (e.g., polyurethane or melamine-based), recycled cellulose fiber (e.g., paper-based acoustic mats), mineral wool or rock wool panels, aerogel-infused acoustic form, and/or any other suitable material. The weight of the middle layer 108 may range from 1000 to 2500 gsm.

The bottom layer 110, which may be directly exposed to the luminaire 112, may include a more controlled and refined finish for optimizing light reflection and diffusion. The bottom layer 110 may use virgin material to improve color consistency, which helps tune the light performance of the light fixture 100. The bottom layer 110 may also use flame-retardant materials to add an extra layer of safety, making the baffle 102 suitable for architectural applications where fire resistance is a consideration. The bottom layer 110 may have a Shore A hardness of 40-70. The bottom layer 110 may be constructed from high-reflectance PET, micro-perforated aluminum panels, pressed wool or synthetic felt panels, acoustic fabric, paper-based composites, and/or any other suitable material. The weight of the bottom layer 110 may range from 400 to 600 gsm. In some examples, the bottom layer may be a white nonwoven PET material. The color of the bottom layer 110 may be white or other light color to improve the reflectivity of light, keeping the reflectivity to be between 60% and 95%. In addition to the color of the material, the bottom layer 110 may be treated to improve reflectivity with treatments such as optical coatings, embedded reflective coatings, nano-reflective surface treatments, and/or the like.

In some embodiments, the baffle 102 may include two, three, four, five, six, etc., layers, one or more of which may be considered a top layer 106, middle layer 108, and/or bottom layer 110.

In some embodiments, one or more sides of the luminaire 112 may include similar material(s) as the top layer 106, middle layer 108, and/or bottom layer 110 for further acoustic treatment.

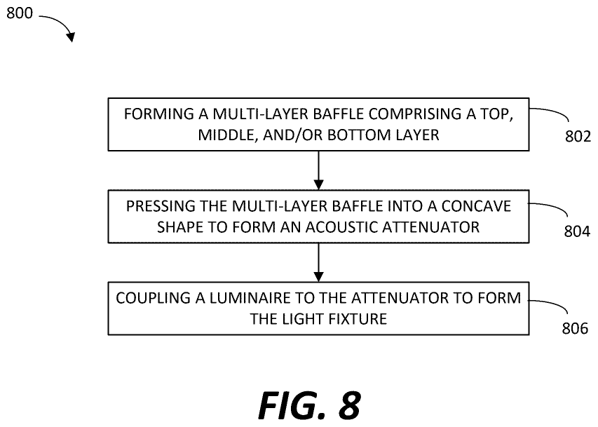

FIG. 8 is a flow diagram of a process 800 of manufacturing the light fixture of FIGS. 1-7. For explanatory purposes, the operations of the process 800 are described herein as occurring sequentially or linearly. However, multiple operations of the process 800 may occur in parallel. The operations of the process 800 need not be performed in the order shown, and one or more operations of the process 800 need not be performed or can be replaced by other operations.

An operation 802 includes forming a multi-layer baffle that serves as both an acoustic attenuator and a baffle (e.g., a light reflector). The top layer (e.g., the top layer 106) is prepared as a structural component of the baffle. This layer may be made from a high-density material, such as compressed polyethylene terephthalate (PET), fiberglass-reinforced acoustic panels, or aluminum composite sheets. The material is selected based on the desired balance of rigidity and acoustic diffusion. For example, a 2300 to 2600 gsm PET sheet with 35% to 55% recycled material provides structural support while allowing for controlled sound interaction. The top layer may be heat-pressed, molded, or laser-cut to achieve the required shape and dimensions.

Next, if the baffle design includes one or more middle layers (e.g., the middle layer 108), it is introduced to enhance sound absorption. A middle layer is composed of a lower-density material, such as open-cell foam, aerogel-infused PET, or recycled cellulose fiber, with a weight ranging from 300 to 1000 gsm. One example is a 400 to 600 gsm PET sheet with 30% to 50% recycled content, which absorbs mid-to-high frequency sound waves. The middle layer may be bonded to the top layer using an adhesive or thermal lamination process, providing a seamless connection while maintaining porosity for acoustic performance.

Finally, the bottom layer (e.g., the bottom layer 110) is introduced to interface between the luminaire (e.g., the luminaire 112) and the baffle. The bottom layer is acoustically functional and/or optimized for light reflection. For example, a 450 to 550 gsm PET layer with 50% to 70% flame retardant fibers, and 100% virgin material is used for controlled color consistency and reflectivity. Alternatively, materials such as micro-perforated aluminum, high-reflectance PET, or wool-based acoustic felt can be selected based on the desired balance of light diffusion and sound absorption. The bottom layer may be applied to the one or more middle layers (if present) or directly to the top layer. The bottom layer may be bonded through heat pressing, ultrasonic welding, or specialized adhesives that preserve the acoustic properties of the material.

Throughout this step, precise layering techniques are used to control the thickness variation of the baffle, which may range from 5 mm at its thinnest points to 20 mm at its thickest areas. CNC cutting or die-cut stamping may be employed to ensure uniformity and to create any necessary contouring or perforations. Depending on the design specifications, additional surface treatments, such as coatings for enhanced reflectivity or fire retardancy, can be applied to the bottom layer.

An operation 804 includes pressing the multi-layer baffle (e.g., the baffle 102) into a substantially concave shape to form an acoustic attenuator. The multi-layer baffle may be placed into a precision mold or press designed to shape it into the desired concave geometry. The degree of concavity may vary depending on the intended application. For example, a linear concavity may be used for uniform light redirection, while a nonlinear curvature—where the center remains flatter while the edges curve more aggressively—may provide enhanced acoustic performance by increasing surface interaction with sound waves.

The pressing process can be achieved through one or more manufacturing techniques, depending on the material composition of the baffle. One approach is thermal forming, where controlled heat is applied to soften the PET or composite layers, allowing the baffle to be pressed into the desired concave shape. This approach may be particularly effective for high-bico-content PET layers, which respond well to heat activation, enabling them to be reshaped while maintaining structural integrity.

In some embodiments, for more rigid top layers, such as compressed fiberglass, aluminum composites, or high-density PET panels, a cold-press molding process may be used. In this approach, the baffle is placed into a substantially concave mold and subjected to mechanical pressure without heat, allowing the material to take on the new shape while preserving its structural properties. Adhesives or secondary reinforcements may be applied to maintain the concavity in cases where the material has lower shape memory.

In some embodiments, vacuum forming may be used, particularly useful for thinner baffles or configurations that require gradual, even pressure distribution. In this approach, the baffle is placed over a substantially concave mold, and a vacuum is applied to pull the material into shape.

Once the pressing process is complete, the shaped baffle (the baffle 102) may be cooled and stabilized so it can retain its substantially concave form. This may involve setting the baffle in a controlled cooling environment or applying post-processing reinforcements such as edge stiffeners or embedded ribs to maintain its structural stability over time. If necessary, surface refinements such as additional reflective coatings, perforations for airflow control, or edge trimming may be applied.

An operation 806 includes coupling a luminaire to the baffle to form the light fixture (e.g., the light fixture 100). The luminaire may take various forms, including LED modules, linear light engines, or diffused panel lights, depending on the lighting performance requirements. The luminaire may be positioned below the baffle, allowing light to be projected upward toward the bottom surface of the baffle. The baffle reflects the light such that the light is redistributed downward in a soft, indirect manner, reducing harsh glare, and creating a soft illumination effect.

The luminaire may then be mechanically coupled to the baffle using one of several possible attachment methods. One approach is stem mounting, where the luminaire is suspended from the ceiling using a rigid stem (e.g., the suspension mechanism 120) that passes through the baffle (e.g., at the attachment mechanism 118), providing structural support and electrical connectivity. In some embodiments, direct-to-grid or direct-to-strut mounting can be employed for fixtures installed in modular ceiling systems.

In some embodiments, the luminaire may be recessed into a dedicated opening within the baffle, allowing the light source to be partially enclosed by the baffle while still directing light upward toward the baffle. To facilitate this, pre-cut openings or custom-molded recesses may be incorporated into the baffle during the forming process.

Electrical connections may be established by routing power cables through the mounting system (e.g., the suspension mechanism 120), which may be concealed within the suspension hardware. In embodiments using a remote power supply, the luminaire may be wired to an external driver located in a ceiling junction box or remote electrical enclosure, reducing bulk and improving the overall profile of the light fixture. Some embodiments may also incorporate dimmable or tunable white or RGB LED systems, allowing users to adjust brightness and color temperature for enhanced lighting control.

In summary, the light fixture 100 may be a pendant light with an integrated baffle 102, combining both illumination and sound attenuation in a single suspended unit. Unlike conventional pendant lights, the light fixture 100 features a multi-layer baffle 102 optimizing acoustic absorption and controlled light effects. Positioned below the baffle 102, the luminaire 112 projects light upward, which is then redirected downward by the surface of the baffle 102, softening light, reducing glare, and providing uniform illumination. The layered construction of the baffle 102, which may include multi-density PET construction, enhances its sound-dampening performance while fine-tuning light diffusion. This dual-function design makes the light fixture 100 particularly valuable in architectural spaces, offering an elegant solution for environments requiring both acoustic comfort and ambient lighting control.

Acoustic testing of an example embodiment of the baffle 102 demonstrated notable acoustic absorption capabilities, particularly in the mid-to-high frequency ranges, making the baffle 102, and thus the light fixture 100, particularly suitable for reducing reverberation and improving speech intelligibility. The example embodiment of the baffle 102 included a top layer of 100% polyester fiber weighing between 1000 and 1500 gsm, a middle layer of 100% single-polymer polyester PET fiber weighing between 1900 and 2400 gsm, and a bottom layer of white nonwoven PET weighing between 200 and 700 gsm.

The test was carried out according to American Society for Testing and Materials (ASTM) C423-23, which determines sound absorption coefficients using the reverberation room method, and ASTM E795-23, which outlines specimen mounting practices. The tested configuration included six hexagonal baffles arranged in two rows of three, each suspended from cables with a spacing of 6 inches between units and rows. The baffles varied in thickness from 5 mm to 20 mm, with an overall object depth of 3 inches and a total weight of 22 kg. The test conditions were carefully controlled, maintaining a temperature of 22.1° C., relative humidity of 56.4%, and a reverberation chamber volume of 291.98 m³. Each baffle had an exposed surface area of 1.72m², leading to a total effective sound-absorbing area of 10.3 m². The mounting method simulated a typical ceiling baffle installation, where the closest face of the objects was positioned approximately 56.75 inches from the horizontal test surface.

The total absorption values were measured in square meters and Sabins at each one-third octave frequency band. The absorption generally increased with frequency, demonstrating a trend where higher frequencies were absorbed more effectively than lower ones. At lower frequencies, particularly around 100 Hz, the absorption was relatively modest, with a total absorption value of 0.61 m² or 6.53 Sabins. As the frequency increased, absorption performance improved significantly. For example, at 250 Hz, the absorption reached 3.05 m² (32.84 Sabins), and by 500 Hz, it increased to 4.92 m² (52.94 Sabins). This upward trend continued across mid-range and high frequencies, with absorption values reaching 6.89 m² (74.12 Sabins) at 1000 Hz and peaking at 9.47 m² (101.94 Sabins) at 5000 Hz.

In addition to total absorption, the test also calculated sound absorption per square meter of extended continuous surface. This measure, denoted as SA/m², followed a similar pattern, increasing from 0.07 at 100 Hz to 1.12 at 5000 Hz. The highest absorption efficiency was observed in the 2000 Hz to 5000 Hz range, where SA/m² values exceeded 1.0, suggesting strong performance in attenuating high-frequency noise.

The overall performance of the baffle 102 was summarized using two ratings: the noise reduction coefficient (NRC) and the sound absorption average (SAA), both of which were calculated at 0.70.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A light fixture comprising:
a substantially concave, multi-layer baffle including:
a first layer composed of a first material having a first weight, the first layer being configured to attenuate sound; and
a second layer composed of a second material having a second weight, the second layer being configured to reflect light; and
a luminaire positioned below the baffle and configured to emit light at least partially toward the second layer, wherein the second layer redirects the emitted light away from the baffle.

2. The light fixture of claim 1, wherein the baffle further comprises a third layer composed of a third material having a third weight.

3. The light fixture of claim 2, wherein the first layer is a top layer, the second layer is bottom layer, and the third layer is a middle layer between the first layer and the second layer.

4. The light fixture of claim 2, wherein the first layer represents substantially 33% of the baffle, the second layer represents substantially 13% of the baffle, and the third layer represents substantially 54% of the baffle.

5. The light fixture of claim 2, wherein the third layer has a weight between 1000 and 2500 gsm.

6. The light fixture of claim 1, wherein a bottom surface of the baffle has a reflective surface configured to reflect the emitted light away from the baffle.

7. The light fixture of claim 1, wherein the baffle has a non-uniform thickness.

8. The light fixture of claim 7, wherein the baffle has a maximum thickness of substantially 20 mm at its center and a minimum thickness of substantially 5 mm at its edge.

9. The light fixture of claim 1, wherein the baffle has a rounded hexagonal form.

10. The light fixture of claim 1, wherein the baffle has a nonlinear curvature.

11. The light fixture of claim 1, wherein the luminaire is mechanically coupled to the baffle.

12. The light fixture of claim 1, wherein the luminaire comprises a top surface facing toward the baffle and a bottom surface facing away from the baffle, and the bottom surface includes at least one of the first material or second material.

13. A method of manufacturing a light fixture, the method comprising:
forming a multi-layer baffle comprising a top layer, a middle layer, and a bottom layer, each layer having a different material weight;
pressing the multi-layer baffle into a substantially concave shape; and
positioning a luminaire below the multi-layer baffle to form the light fixture, wherein the luminaire emits light at least partially toward the multi-layer baffle and the multi-layer baffle redirects the emitted light away from the multi-layer baffle.

14. The method of claim 13, wherein the top layer is substantially 33% of the multi-layer baffle, the middle layer is substantially 54% of the multi-layer baffle, and the bottom layer is substantially 13% of the multi-layer baffle.

15. The method of claim 13, wherein the top layer has a weight between 890 and 1420 gsm, the middle layer has a weight between 1000 and 2500 gsm, and the bottom layer has a weight between 400 and 600 gsm.

16. The method of claim 13, wherein a bottom surface of the multi-layer baffle has a reflective surface configured to reflect the emitted light away from the multi-layer baffle.

17. The method of claim 13, wherein the multi-layer baffle has a non-uniform thickness and a nonlinear curvature.

18. The method of claim 13, wherein the luminaire is suspended from the multi-layer baffle.

19. An acoustic attenuator comprising:
a substantially concave, multi-layer baffle having a non-uniform thickness, the multi-layer baffle comprising:
a first layer composed of a first material having a first weight, and
a second layer composed of a second material having a second weight different from the first weight.

20. The acoustic attenuator of claim 19, wherein the multi-layer baffle further comprises a third layer composed of a third material having a third weight different from both the first and second weights.

21. The acoustic attenuator of claim 20, wherein the third layer includes a bottom surface configured to reflect light away from the bottom surface.

22. The acoustic attenuator of claim 20, wherein the first layer is substantially 33% of the multi-layer baffle, the second layer is substantially 54% of the multi-layer baffle, and the third layer is substantially 13% of the multi-layer baffle.

23. The acoustic attenuator of claim 19, further comprising a receptacle for receiving a luminaire at a center of the acoustic attenuator.
